(19) United States
(12) Patent Application Publication
(10) Pub. No.: US 2003/0013459 A1
(43) Pub. Date: Jan. 16, 2003

(54) Method and system for location based recordal of user activity

(75) Inventors: Paul J. Rankin, Horley (GB); David P. Walker, Redhill (GB); David A. Bell, London (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/188,137

(22) Filed: Jul. 2, 2002

(30) Foreign Application Priority Data
Jul. 10, 2001 (GB) 0116821.0
May 14, 2002 (GB) 0210947.8

(51) Int. Cl. H04M 3/42; H04Q 7/20

(52) U.S. Cl. 455/456; 455/414

(57) ABSTRACT

A system for location-based recordal of user activity comprising a portable device (20) for issue to a user, the device (20) having an associated unique identifier, a plurality of detectors (30) configured to detect the device (20) and obtain the unique identifier of the device (20), wherein each detector (30) is configured to log the location of the user at the predetermined location upon detection of the device (20), the system further comprising a number of activity sensors (50, 60, 70, 80) directed to one or more of the locations, each activity sensor (50, 60, 70, 80) being configured to record activity upon detection of the device (20) at the respective location.

The present invention relates to a method and system for recording a user's activity based on their location. The present invention is particularly applicable for use in theme parks, holiday resorts and other activity resorts.

The use of user tracking and video surveillance technology is typically limited to office and security environments. Various systems have been tested in a research environment, such as the Hewlett Packard “Cool Town” system. Such systems either (a) locate users using a central-tracking system; or conversely (b) allow users to ascertain their location from an installed infrastructure.

“Big Brother” privacy concerns have limited the success of centralised tracking systems, even with their associated benefits in terms of helpfulness and user device simplicity, cost and unobtrusiveness.

When visiting theme parks, skiing resorts and other activity centres, the sole aim of a user is to achieve as much enjoyment and relaxation as possible. Many users wish to obtain momentos of their visit and are often forced to carry expensive cameras and video recording equipment if they wish those momentos to be of a personal nature as apposed to the generic gifts and postcards otherwise on sale. A particular problem is that in many cases, the environment of the theme park or skiing resort is such that cameras and video recording equipment could be lost, damaged or merely prove inconvenient to carry.

Whilst theme parks and the like offer photographic systems to users on rides, the user has to wait for the photo to be printed, identify, pay for and collect his own photo(s) from all those photos taken on that particular ride, and carry it around for the rest of the day. This disrupts the flow of the visitor's day. Sound recordings are rarely captured in an energetic ride.

A system developed by Lo-Q has been used to locate users. The Lo-Q system relies upon a small wireless device (referred to as a Q-Bot) hired out to each visiting group. Through a network of base stations, devices are updated with times at which each ride may be visited. Information is shown on a small screen and users can reserve a place on a ride by holding their Q-Bot in close proximity to a kiosk by the ride. Using information on the size of the queue (fed to the system by ride operators) and details of which rides the group may go on (based on, for example, height or age restrictions) the system then allocates time slots. Upon returning later, visitors join a shorter priority queue. A receiver by the entrance to the ride communicates with the visitor's Q-Bot. If the visitors are permitted to go on the ride, a green light is flashed for the benefit of the rider operator. Additionally, alarms may go off if the Q-Bot is taken from the park. A child finder service is possible with simple display-less tags.

In accordance with one aspect of the present invention, there is provided a system for location-based recordal of user activity comprising a portable device for issue to a user, the device having an associated unique identifier, a plurality of detectors configured to detect the device and obtain the unique identifier of the device, wherein each detector is configured to log the location of user at the predetermined location upon detection of the device, the system further comprising a number of activity sensors directed to one or more of the locations, each activity sensor being configured to record activity upon detection of the device at the respective location.

The system may further comprise a computer system in communication with the detectors and activity sensors, wherein each detector is configured to communicate the log of user locations to the computer system and the activity sensors are configured to communicate recorded activity to the computer system.

The computer system may be arranged to compile recorded activity of a user from the communicated recorded activity in dependence on the log of user locations communicated by the detectors. Preferably, the computer system is arranged to submit the compilation to the user for later review. The compilation may be submitted in a format selected from a set including: video; email; DVD; paper print-outs or data on a computer readable medium. The compilation may be submitted in exchange for a fee.

Roaming detectors may be utilised including a location determination system, the roaming detector being configured to detect the device and obtain the unique identifier of the device, wherein the roaming detector is arranged to log the location of the user at a location determined from the location determination system.

The activity sensors may be selected from a set including: video camera, still picture camera, microphone, biosensors and sensory capture devices.

Communication may be performed via a wireless communication network. The communication network may be BlueTooth.

Preferably, the detectors and sensors are directed to rides and/or attractions within a theme park.

According to another aspect of the present invention, there is provided a method of location-based recordal of user activity comprising:

issuing a portable device to a user, the user having an associated unique identifier;

monitoring for the device with a detector arranged to detect the device when at a determined location;

obtaining the unique identifier at the detector of detected devices;

triggering an activity sensor directed to the location upon detection of a device at the location; and

recording output from the activity sensor with a link to the unique identifier for compilation of user activity.

Examples of the present invention will now be described in detail, by way of example only, with reference to the accompanying drawings in which:

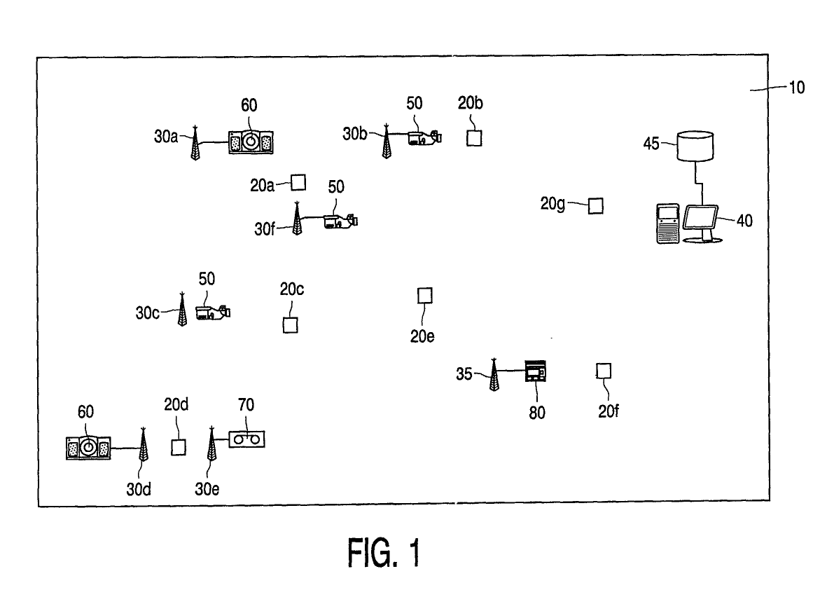

FIG. 1 is a schematic drawing of a plan of a theme park incorporating detection zones for use in the present invention;

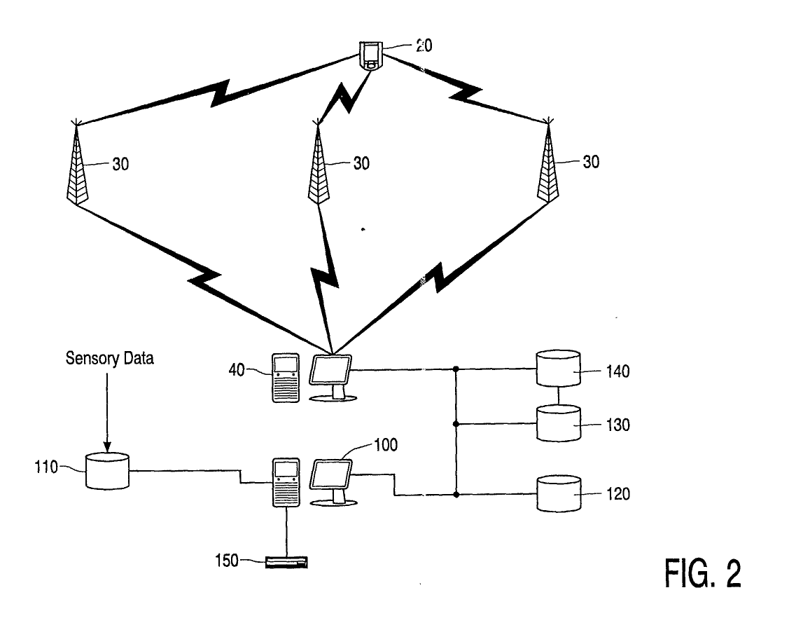

FIG. 2 is a schematic diagram of an architecture for capture and logging of location-based user data for use in accordance with the present invention; and,

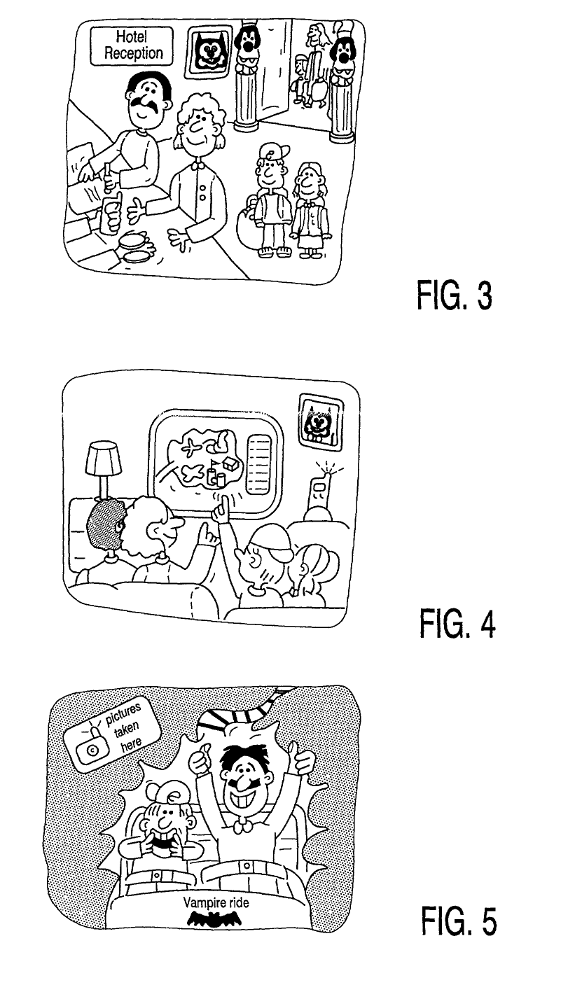

FIGS. 3 to 8 are illustrations depicting operation of a system in accordance with various aspects of the present invention.

FIG. 1 is a schematic diagram of a plan of a theme park incorporating detection zones in accordance with the present invention.

Upon visiting a theme park 10, a user is issued with one of a number of unique identification devices 20 (a number of such devices are illustrated by way of example as separate entities 20a-20g respectively). Each device 20 is either carried or worn. Upon issuing the device 20, details of the user are stored in a database 45 on a central server 40. The user details are associated with the unique identifier of the device 20. Throughout the theme park 10, a network of detectors 30a-30f are distributed that are able to sense the presence of a device 20 carried or worn by a visitor via RF technology.

Data obtained from the device 20 allows the detectors 30 to recognise the device 20 and correlate it with the database 45 to obtain the user data. The devices 20 may, for example, simply send a one-way connectionless RF broadcast of a unique identifier associated with the device 20 to detectors 30 within range. Alternatively, the devices 20 may employ passive RFid technologies within meter-range sensing devices. More advanced devices may offer user input/output, for example PDA-like functions and have other options for network connections, such as GSM, GPRS etc. as well as the local RF link.

By identifying the user from the unique identifier of the device 20 and identifying the detector 30 detecting the device 20, the central server 40 can discover the location of the user within the park 10.

Once discovered, monitoring the users' activity can be done via a range of sensory equipment 50-80 linked to the detector 30 and/or directed to the particular location of the user. The sensory equipment 50-80 is primarily directed to the recording of audio and video material and may include video capture equipment 50, still picture capture equipment 60 and audio capture equipment 70. Other equipment 80 may be incorporated into the user's device 20 or otherwise issued to a user to capture user sensory data such as heart rate, arousal and breathing rate when triggered by a detector 30 due to the proximity of the user device 20. Sensor data captured by the equipment 50-80 might be correlated later by the central server 40 with the user's location and activity recordings. Such an arrangement enables a heart rate trace of the user to be shown alongside their video recording, or the highlighting of a users most frightened experience at a certain point on a ride in subsequent social activities.

Data from the equipment 50-80 is relayed to the central server 40 which adds the data to the database 45. From the data, the server 40 can infer the users' paths, or at least a sequence of ‘RF sightings’. This information can then be used to compile a personal montage of recorded material about a particular user's movements and activities.

The stored user-location data information may be both personal and of commercial value. System operators are therefore expected to adhere to a published privacy policy and deploy a trustworthy secure system for their databases and the connected networks and applications.

Various policies may be applied to the expiry and deletion of both the location log and the correlated audio-video-sensory data repository to keep these within manageable and cost-effective limits. However, value is seen in retaining the data to enhance the experience on a return visit to the environment, or an affiliated locale. Such retention can be used to increase revisits and customer loyalty through accumulated personalisation.

Enhancements to return visits could be offered by route/itinerary suggestions based on previous visits, identified favorite rides, new rides, rides missed on previous visits, routes taken by family or friends or the like.

It is not necessary for detectors 30 to cover the whole of the park 10. Whilst complete coverage would be best for providing an exact location of each user and their paths, detectors 30 need only be placed close to key areas of interest to capture the presence of the user when interesting things are happening. The fixed network of detectors 30 could be augmented by a number of mobile detectors 35 carried by environment employees, robots, park/ride attraction equipment or transport devices roaming the park 10. Such mobile detectors 35 may use wireless or satellite up-links to transfer user discovery and location logs or sensory data to the central server 40. Alternatively, the mobile detectors 35 may periodically dump the data and recordings into the database 45. The mobile detectors 35 may employ an auxiliary positioning system to fix their own location and in turn the locations of nearby users.

The ‘Area of Interest’ describes the environment in which the user wishes to be monitored, examples of which are theme parks, ski resorts, water parks. Although described herein with reference to smaller closed environments, it will be recognised that the present invention may easily be extended to cover larger areas such as towns and cities.

FIG. 2 is a schematic diagram of an architecture for capture and logging of location-based user data for use in accordance with the present invention.

The central server 40 includes a database server 100 managing databases including a sensory database 110 and a user location database 120. The databases 110, 120 managed by the database server 100 make up the database 45 referred to above. User information is maintained in a user database 130 and environment, service and event information is maintained in a park database 140. The network of detectors 30, 35 communicate with the central server 40 and provide data on discovered user devices 20.

When a user device 20 is discovered by a detector 30, the detector 30, transmits the unique identifier of the device 20 along with a unique identifier of the detector (although this may be implicitly transmitted by some identifier in the transmission itself) and a timestamp indicating when the device was discovered to the central server 40. The central server 40 submits the location data transmitted by the detector 30 to the database server 100 for recordal in the user location database. The identity of the user may be obtained from correlation of the unique identifier in the user database 130 when location data is received or it may be obtained at a later point when it is required. Preferably, the central server 40 is alerted by detectors 30, when a device 20 comes into range or moves out of range. If a detector 30, may periodically send a list of all devices 20 in range or the detector 30, could list all devices 20 in range upon demand.

Sensory data captured by sensory equipment 50-80 is recorded in the desired sensory database 110.

The central server 40 includes an output interface 150 that is connected to the database server 110 for obtaining user data and associated sensory data and location data from the respective databases.

Based on such a system, we now describe a number of techniques to enable the provision of new services, souvenir sales and revenue streams.

The network of detectors 30 could, for example, be a network of BlueTooth sensing devices, also called “Beacons”. These are distributed across the area of interest that detect the presence of other BlueTooth devices. In this scenario, the devices 20 would incorporate BlueTooth technology. This would allow a system to accurately locate a device held or carried by a user to within 10 meters. Alternatively, other wireless technologies could be used, such as RF Light (Zigbee) or wireless LAN (802.11). Optionally, with some augmentation (for example timing calculations), the accuracy of positioning information provided could be improved. A BlueTooth device 20 may be in a permanently “discoverable” mode to release its BlueTooth device ID to a “split beacon” inquirer radio (as described in commonly-assigned UK patent application number 0020101.2), but not participate in piconet applications. If more secure user identification is required, a more complex but fast-inquiry/discovery, followed by a device authentication protocol may be employed.

The one-way or mutual discovery of user devices and detectors may be made more efficient, for example, by synchronising the regular RF emissions from active devices with detector polling to discovery devices in its proximity, as is done with 802.11 to save battery power.

Referring to FIG. 3, a visitor, or group of visitors arrives at the location, or its associated accommodation and rents or are issued for free with, one or more handsets on loan, equipped with short-range RF technology, such as Bluetooth, RF Lite/Zigbee, RFiD tags, or 802.11. These devices 20 can be detected and located to a few metres by detectors 30 the system's infrastructure

The identity and broad characteristics of the visitor or group are registered in the central server 40 (family size, gender, ages etc). A check is made for previous visits by party members on the central database 45 or authorised databases of other or associated environments.

Referring to FIG. 4, optionally, a planning stage may be offered, when the preferences of the group are solicited by an introductory system and appropriate recommendations given. These may be used in targeting offers or e-coupons using an anticipation of the path that group intends to take or, for example, to offer navigation assistance.

Through the registration of the visitors, any prior visits—along with experiences they had, such as the rides that were taken or social encounters which had been logged by the system on previous visits to this (or similar associated) resorts—are recalled from the central database 45. This data can be used to advertise changes to the environment since the last visit, suggest new experiences or challenges, these being based on skill levels or experiences previously recorded by the system. This recommendation system can increase customer loyalty, return visits and so turnover for the environment owner. It can also help to target location-based offers or e-coupons during the visit to the environment. Currently, systems to log the detailed experiences and performances of individual visitors to such environments are too expensive or intrusive to deploy.

Referring to FIG. 5, the system can be used to automatically detect which users are on a particular ride and when, to take photographs or video the user on the ride, optionally capture sound recordings (in-car speech, screams etc) and mark the recordings with the user's id and timestamps. The user does not have to wait around after the ride to get his photograph but instead can have the photograph delivered later. Alternatively the audio-video recordings can be collected on exit or back at an affiliated hotel, using the mobile device to prove identity. The user may view the image directly after the ride when he can decide if he wants to purchase the picture, or postpone that decision. Alternatively the user could download their images and/or sound recordings from a theme park web site after returning home.

Increased souvenir sales will result from automating this process and offering new types of material.

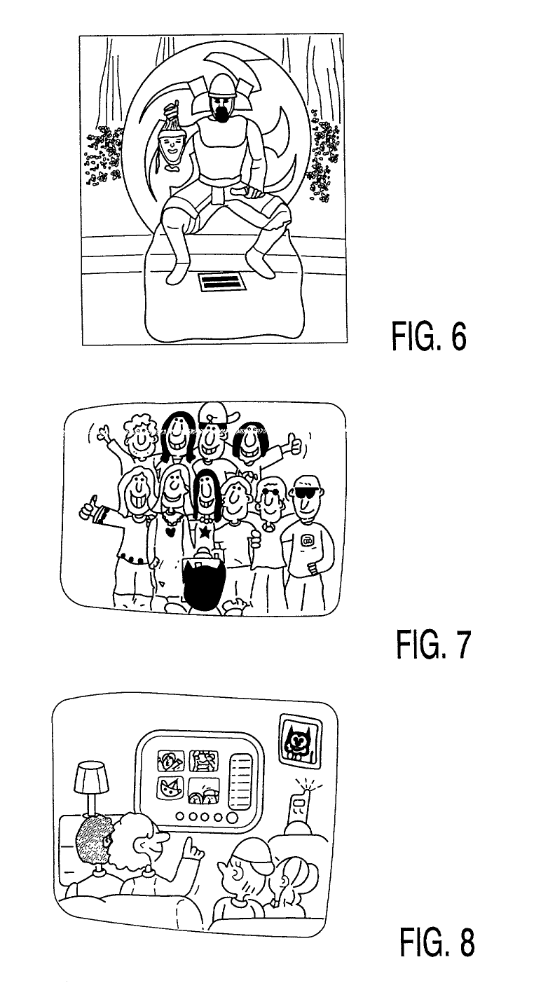

Referring to FIG. 6, the system recognises the presence of user(s) in photo-booths or photo spots and can automatically take the photo, suitably preceded by an automatic countdown warning. The photo is then stored along with the user's tag id in a central content database 45, so that the user(s) may access the photograph at a later time. The user does not have to carry the camera or the photo around.

The identities of participants in group photos, or those on a ride together at a certain time can be logged. The system can therefore track the social grouping of visitors, and adjacency to other visitors who may be strangers. This might be used subsequently in the design of social games or, for example, as an introductory service to strangers who have shared close experiences (in time or place) and who consent to the sharing of their location tracking data to such services. New revenue may be created from such social services.

Referring to FIG. 7, roaming employees of the environment, such as photographers, interviewers or video cameramen, can be equipped with mobile detectors 35 to automatically detect the presence and identity of nearby visitors carrying or wearing the devices 20. Directional RF antennae can be used to restrict the detection cone, and the sensitivity adjusted to a suitable range to be more accurate in correlating recordings with visitors. Such employees may be celebrities or dressed as well-known characters. The employees may use another more cumbersome or expensive locating system (eg GPS) to establish their position in the park 10 at any one time. This positional data can therefore be added to A/V recordings made, thus extending the tracking of visitors to cover places where they are out of range of the fixed detector infrastructure.

These employees can selectively record the visitors nearby, the resulting recordings being automatically tagged by time, place and the identities of visitors within the employee's RF detection range. These recordings are then transferred to the central database 45 (via immediate wireless uplink, or at a special A/V transfer station) and stored along with the user's tag id so that the user may access the audio, video or photographic recordings at a later time. Again, the user does not have to carry the camera or the photo around. New types of valued experiences, rich memories and special encounters can thus be captured—for later sale, or to increase the customer loyalty and likelihood of repeat visits (again generating increased turnover).

As the system automatically keeps a visual record of the user's recent history this may be used for security purposes. For example if a user has some item stolen it is possible to re-trace the user's movements and search back to the point where the theft occurred and identify the culprit. The system may also be used to find where a user has lost something he was carrying.

This is especially useful when children go missing—it will be possible to review the child's path and determine if the child had been approached by other persons. This will give the parents peace of mind that even when they are not able to monitor their children, the system will. Similarly if an accident occurs this may be replayed at a later time to help establish cause and apportion blame.

Referring to FIG. 8, the system automatically compiles a montage of the users' activity and presents these at the end of the day's visit, or at a later date so that users can share their experience with each other, friends and family.

This ‘afterglow’ or ‘apres-ski’ re-living of the day and comparison of the different experiences in a group can be very enjoyable, stimulating social interactions in the affiliated resort accommodation, public or private meeting areas. The system can also automatically compile all the shots taken in a place, by the roaming employees, or on a certain point of a ride in which the user has participated. This enables the running of automated competitions, e.g. funniest ride of the day, and allows comparisons with other user's skills or reactions during an event or challenge in the environment. Such new ‘afterglow’ services can command new revenue for the owner of the environment.

The audio/video souvenirs could be automatically burned (after possible user editing) onto a CD, or made into a video tape for the user to take home, easily mailed or emailed to friends and family or published on a secure web site. In the theme park scenario this could show the user going on rides, and allow the user to re-trace his/her route. In the ski resort scenario this would allow the user to view video footage of his/her descent. This material may be easily compiled with content and contextual information provided by the environment owner which is relevant to the path and experiences of the user. For example, this information may be about the ride taken in a theme park, the current weather conditions when the ski run was taken, or the people that accompanied the user (if they have consented to the sharing of their location data). A user may then purchase these individualised informational material and A/V souvenirs, thus providing a new revenue stream. This compares favourably to current solutions, where the user is left to capture images or video for himself for later viewing.

Throughout the environment, ride tolls or purchases can be accumulated centrally, by using the user's unique identifier provided by the device 20 for registration. Central billing systems are known to increase sales as compared with individual payments for each offering.

Many other valuable applications than those given above are possible once the RF locating system is installed—for example locating lost children who have their own user device (eg a tag in a bracelet), facilitating group meetings, establishing communication links between members of the same party on more advanced user devices, electronically receiving special offers or coupons etc.

As described herein, the invention describes many new concepts and services based on a system recording a user's activity by monitoring their location over a period of time. The services are based around a user spending a day in a theme park or similar environments—cities, skiing or activity resorts—where the user may wish to plan beforehand or recall his/her activities at a later time. The user carries a small device which can be located by an infrastructure of beacons that are distributed throughout the theme park. The system can detect the user's presence or movements and use additional technologies to record the user's activity—video camera, audio. These may be fixed, or carried by roaming employees of the environment. The system can then compile a summary of the user's recent activity and present this to the user at a later time to provide the user with a record of his recent activity. Several new business methods are provided based on knowing the user's path and provision of services, especially in the affiliation between activity resorts and their local accommodation or relaxation places. These may include selling the automatic compilation of souvenirs, targeted e-couponing, facilitating social games or introductory services, lotteries, competitions or social events (best of day, winner of funniest situation, ride of the day, and so forth).

Although defined principally in terms of a software-based or controlled implementation, the skilled reader will be well aware than many of the above-described functional features could equally well be implemented in hardware or a combination of software and hardware.

From reading the present disclosure, other modifications will be apparent to persons skilled in the art. Such modifications may involve other features which are already known in the design, manufacture and use of communications and monitoring systems and/or data network access apparatus and devices and component parts thereof and which may be used instead of or in addition to features already described herein.

1. A system for location-based recordal of user activity comprising a portable device for issue to a user, the device having an associated unique identifier, a plurality of detectors configured to detect the device and obtain the unique identifier of the device, wherein each detector is configured to log the location of the user at the predetermined location upon detection of the device, the system further comprising a number of activity sensors directed to one or more of the locations, each activity sensor being configured to record activity upon detection of the device at the respective location.

2. A system according to claim 1, further comprising a computer system in communication with the detectors and activity sensors, wherein each detector is configured to communicate the log of user locations to the computer system and the activity sensors are configured to communicate recorded activity to the computer system.

3. A system according to claim 2, wherein the computer system is arranged to compile recorded activity of a user from the communicated recorded activity in dependence on the log of user locations communicated by the detectors.

4. A system according to claim 3, wherein the computer system is arranged to submit the compilation to the user for later review.

5. A system according to claim 4, in which the compilation is submitted in a format selected from a set including: video; email; DVD; paper print-outs or data on a computer readable medium.

6. A system according to claim 4, in which the compilation is submitted in exchange for a fee.

7. A system according to claim 1, further comprising a roaming detector including a location determination system, the roaming detector being configured to detect the device and obtain the unique identifier of the device, wherein the roaming detector is arranged to log the location of the user at a location determined form the location determination system.

8. A system according to claim 1, wherein the activity sensors are selected from a set including: video camera, still picture camera, microphone, biosensors and sensory capture devices.

9. A system according to claim 1, wherein communication is performed via a wireless communication network.

10. A system according to claim 9, wherein the communication network is BlueTooth.

11. A system according to claim 1 wherein the detectors and sensors are directed to rides and/or attractions within a theme park.

12. A method of location-based recordal of user activity comprising:
issuing a portable device to a user, the user having an associated unique identifier;
monitoring for the device with a detector arranged to detect the device when at a determined location;
obtaining the unique identifier at the detector of detected devices;
triggering an activity sensor directed to the location upon detection of a device at the location; and
recording output from the activity sensor with a link to the unique identifier for compilation of user activity.
